(19) United States
(12) Patent Application Publication
(10) Pub. No.: US 2008/0107277 A1
(43) Pub. Date: May 8, 2008

(54) Classroom sound amplification system

(75) Inventors: Deepak Somasundaram, Petaluma, CA (US); Tom Flaherty, Petaluma, CA (US)

Correspondence Address: BIRCH STEWART KOLASCH & BIRCH, PO BOX 747, FALLS CHURCH, VA, 22040-0747, US

(73) Assignee: PHONIC EAR INC., Petaluma, CA (US)

(21) Appl. No.: 11/546,425

(22) Filed: Oct. 12, 2006

(51) Int. Cl. H04R 5/00

(52) U.S. Cl. 381/28

(57) ABSTRACT

This invention relates to a wireless classroom sound amplification system. The system comprises a microphone device converting a voice to a sound signal and connecting to a sound processing device processing the sound signal and generating a processed sound signal, and a speaker device connecting to the sound processing device and converting the processed sound signal to a processed voice. The sound processing device further comprises a feedback cancellation unit identifying acoustical feedback in the sound signal and removing the acoustical feedback in the sound signal.

### FIELD OF INVENTION

This invention relates to a classroom amplification system i.e. a system used for enhancing the sound so as to increase the learning for students, such as a public address sound system or an assistive learning system.

### BACKGROUND OF INVENTION

Generally, state of the art classroom sound systems involve a microphone worn by a teacher and connected to an amplifier, which amplifies the teacher's voice and communicates an amplified signal to a set of speakers situated in the classroom. As the teaching format has evolved from classical lectures given from a generally fixed position in front of a blackboard to computer power point presentations and a moving teacher moving around in the classroom, the requirements of a classroom sound amplification system has simultaneously increased. For example, the movement of the teacher requires the classroom sound amplification system to be able to compensate for acoustical feedback generated when the teacher, for example, moves the microphone closer to one of the speakers.

Further, co-pending provisional US patent application entitled: “Feedback cancellation in a sound system”, assigned to the assignee of the present application and incorporated into the below specification by reference, discloses a feedback cancellation system and method to be implemented in a sound system.

### SUMMARY OF THE INVENTION

An object of the present invention is to provide an improved classroom amplification system overcoming the drawbacks of prior art sound systems.

It is a further object of the present invention is to improve the learning of students in a classroom environment so that a greater number of students benefit from the teaching.

A particular advantage of the present invention is the provision of a wireless transmission of a teacher's voice enabling the teacher to move freely and un-hindered around amongst the students.

A particular feature of the present invention is the provision of a transmission of images concurrently with transmission of a teacher's voice.

The above objects, advantage and feature together with numerous other objects, advantages and features, which will become evident from below detailed description, are obtained according to a first aspect of the present invention by a wireless classroom sound amplification system comprising a microphone device adapted to convert a voice to a sound signal and connecting to a sound processing device adapted to process said sound signal and to generate a processed sound signal, and a speaker device connecting to said sound processing device and adapted to convert said processed sound signal to a processed voice, and wherein said sound processing device comprises a feedback cancellation unit adapted to identify acoustical feedback in said sound signal and to remove said acoustical feedback in said sound signal.

The term “processed” is in this context to be construed as amplifying a signal according to a transfer function; i.e. the gain is not necessarily constant throughout a frequency bandwidth, or throughout time.

The terms “a” and “an” used in connection with elements of the invention are in this context to be construed as one or more, a plurality, or a multiplicity of elements.

The feedback cancellation unit according to the first aspect of the present invention may comprise a calculating element adapted to calculate a threshold value based on mean magnitude and standard deviation of the sound signal. The feedback cancellation unit may further comprise a FFT element adapted to transform the sound signal into frequency domain, and a peak identification element adapted to identify a peak in the sound signal in frequency domain and to generate a peak signal. The feedback cancellation unit may further comprise a comparator adapted to compare the threshold value with the peak signal and to generate a control signal identifying frequency of the peak. The feedback cancellation unit may further comprise a programmable notch-filter unit adapted to receive the control signal and operable to filter out a bandwidth of the sound signal in accordance with the control signal thereby generating the processed sound signal.

The classroom sound system according to the first aspect of the present invention thus may, advantageously, utilise the fact that vocal sound has a Gaussian distribution in the time domain and the fact that most energy is of the vocal sound is within one standard deviation from the centre frequency. Hence the classroom sound system is particularly useful in situations where vocal sound is to be amplified such as in a classroom.

The microphone device according to the first aspect may comprise a microphone transmitter adapted to transmit the sound signal wirelessly to the sound processing device in accordance with a communication protocol. The communication protocol may be a proprietary protocol or a protocol such as Bluetooth, WLAN, WiMax, Wi-Fi, or other standardised protocols. The microphone transmitter, advantageously, enables the teacher to freely move around in the classroom and provide support for students at their tables or desks. However, having the teacher moving around in the classroom increases the possibility of the occurrence of acoustical feedback since the position of the microphone relative the speaker device may be too close. Hence prior art classroom amplification systems with wireless microphones inherently experience acoustical feedback creating a howling sound from the speakers. The feedback cancellation unit according to the first aspect of the present invention thus, advantageously, ensures dynamic removal of acoustical feedback.

The sound processing device according to the first aspect of the present invention may comprise a sound processing transmitter adapted to transmit the processed sound signal wirelessly to the speaker device in accordance with a communication protocol. The communication protocol may be a proprietary protocol or a protocol such as Bluetooth, WLAN, WiMax, Wi-Fi, or other standardised protocols. The sound processing transmitter thus enables for wireless connection to a speaker device. This further flexibility in movement of the teacher carrying a microphone wirelessly connecting to the sound processing device, which is wirelessly transmitting to a movable speaker device, further increases the possibility for the occurrence of acoustical feedback. Hence the feedback cancellation unit ensures the mobility of the speaker devices as well as the microphone by dynamically removing acoustical feedback when detected.

The speaker device according to the first aspect of the present invention may comprise an interactive white-board. The interactive white-board offer computer-interactive presentation, which offers images together with audio such as the teacher's processed voice. Having the teacher facing an interactive white-board equipped with speakers further increases the possibility of occurrences of acoustical feedback, which, advantageously, is prohibited by the feedback cancellation unit according to the first aspect of the present invention.

The speaker device according to the first aspect of the present invention may comprise a personal computer wirelessly connecting to the sound processing transmitter and/or microphone transmitter and adapted to receive images concurrent to the speaker device generating the processed voice. Hence the personal computer may provide visual support during classes such as, for example, power point shows or other presentational data. The personal computer may comprise a laptop or desktop general purpose computer.

The speaker device according to the first aspect of the present invention may be integral with the personal computer or be external devices plugged to the personal computer. Hence the personal computer allows the teacher to communicate with the students in a classroom by having the microphone device connecting directly to the students' personal computers, while simultaneously presenting visual material either directly, or streamed to the students personal computers.

The personal computer according to the first aspect of the present invention may comprise a wireless receiver connecting to the sound processing transmitter. Hence the wireless receiver may be implemented by a PCMCI card inserted into the personal computer such as WLAN, Wi-Fi, WiMax or Bluetooth.

The personal computer according to the first aspect of the present invention may connect to projecting means adapted to display a visual presentation. The personal computer may further connect to a communications network such as a local area network (LAN), wide area network (WAN), metropolitan area network (MAN), or an internetwork (e.g. the Internet), which communications network is adapted to forward the processed sound signal. The communications network may interconnect the personal computer to a plurality of speaker devices and/or further personal computers. Hence the personal computer may act as a media hub of a classroom.

The personal computer according to the first aspect of the present invention may comprise the sound processing device. The sound processing device may be implemented in the personal computer as a software program.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, wherein:

FIG. 1, shows a overview of a classroom amplification system according to a first embodiment of the present invention;

FIG. 2, shows a block diagram of classroom amplification system according to a second embodiment of the present invention; and

FIG. 3, shows a block diagram of a sound processing device for a classroom amplification system according to the second embodiment of the present invention.

### DETAILED DESCRIPTION OF PREFERRED EMBODIMENTS

In the following description of the various embodiments, reference is made to the accompanying figures, which show by way of illustration how the invention may be practiced. It is to be understood that other embodiments may be utilized and structural and functional modifications may be made without departing from the scope of the present invention.

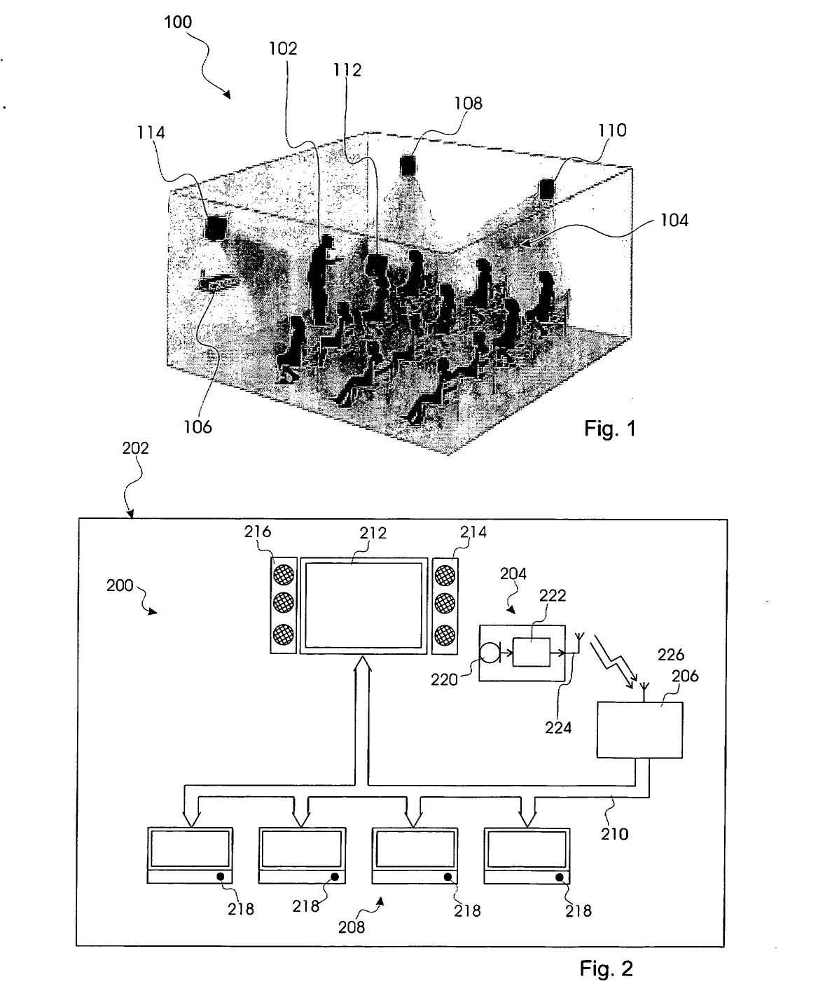

FIG. 1, shows a classroom designated in entirety by reference numeral 100. In the classroom 100 a teacher 102 speaks to an audience of students 104. The teacher 102 carries a microphone device around the neck or attached on a collar of a coat or shirt. The microphone device converts the sound from the teacher 102 to an electric sound signal. The microphone device comprises a transmitter for transmitting the sound signal to a signal processing device 106 receiving the sound signal and performing processing of the sound signal e.g. filtering and amplification. The signal processing device 106 may comprise a transmitter for transmitting the processed sound signal to speaker devices 108, 110, 112 and 114. Alternatively or additionally, the signal processing device 106 may forward the processed signal to the speaker devices 108, 110, 112 and 114 by wire.

FIG. 2, shows a classroom amplification system according to a second embodiment of the present invention and designated in entirety by reference numeral 200. The classroom amplification system 200 positioned in a classroom 202 comprises a microphone unit 204 connecting wirelessly to a computer 206 acting as a hub for a plurality of computers 208. The computer 206 connects to the plurality of computers 208 through a communications bus 210, which may be implemented as a hardwired local area network or a wireless local area network. The microphone unit 204 may also directly connect wirelessly to a plurality of students' personal computers or ultra mobile personal computers (UMPC), acting as local speakers and/or storage devices. The communications bus 210 may further in an alternative embodiment be implemented by a wireless network such as Bluetooth, WiFi or WiMax. Hence the plurality of computers 208 may, for example, connect to the communications bus 210 by means of a PCMCI card.

The communications bus 210 may further connect to a displaying means 212, such as a projector or an intelligent whiteboard also known as smart board. The displaying means 212 may be utilised for presentation of images or text relating to the teaching of students. For example, the teacher may utilise the displaying means 212 for presentation of a power point show of text and/or pictures illustrating the subject to be taught. The displaying means 212 comprises one or more speaker units 214 and 216 presenting the processed voice of the teacher or additional audio determined by the teacher. For example, the teacher may desire to illustrate a certain pronunciation of a word or a particular piece of music and include this in the presentation.

Similarly, the plurality of computers 208 may comprise a speaker unit 218 presenting the processed voice of the teacher or additional audio determined by the teacher.

The microphone unit 204 comprise a microphone 220 for converting the voice of the teacher to a sound signal, a sound processing device 222, such as a digital signal processor, for processing the sound signal in accordance with a transfer function, and an antenna 224 wirelessly transmitting the processed sound signal to the computer 206.

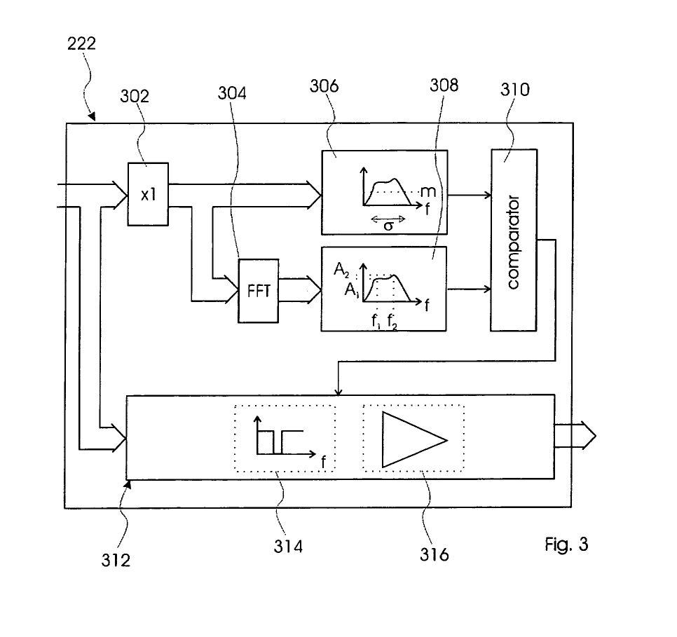

The sound processing device 222 is shown FIG. 3 as a block diagram. The sound processing device 222 comprises an input buffer unit 302 adapted to buffer the digital signals into a number (N) of frames, which are communicated to a FFT unit 304 transforming the frames into frequency domain signals and to a threshold calculation unit 306 adapted to calculate a threshold value from the frame based on mean magnitude (m) and standard deviation (a) of the frames.

The transformed frame is forwarded from the FFT unit 304 to a peak identification unit 308 adapted to identify peaks in the transformed frame and to generate a peak signal for each peak identified in the transformed frame. The peak signal provides information of magnitude and frequency of the peak.

The threshold calculation unit 306 generates a threshold signal for each frame and forwards the threshold signal to a comparator unit 310, which compares the threshold signal to the peak signals received from the peak identification unit 308.

The comparator unit 310 generates a filter control signal in case the peak signal is greater than the threshold value, which filter control signal is forwarded to a filter/amplifier unit 312. The filter/amplifier unit 312 comprises a programmable notch-filter 314 and an amplifier 316, and is adapted to receive the digital sound signal and filter the digital sound signal according to the filter control signal by means of the programmable notch-filter 314, and to amplify the potentially filtered digital sound signal according to a predetermined transfer function by means of the amplifier 316.

1. A wireless classroom sound amplification system comprising a microphone device adapted to convert a voice to a sound signal and connecting to a sound processing device adapted to process said sound signal and to generate a processed sound signal, and a speaker device connecting to said sound processing device and adapted to convert said processed sound signal to a processed voice, and wherein said sound processing device comprises a feedback cancellation unit adapted to identify acoustical feedback in said sound signal and to remove said acoustical feedback in said sound signal.

2. A wireless classroom sound amplification system according to claim 1, wherein said feedback cancellation unit comprises a calculating element adapted to calculate a threshold value based on mean magnitude and standard deviation of the sound signal, a FFT element adapted to transform the sound signal into frequency domain, and a peak identification element adapted to identify a peak in the sound signal in frequency domain and to generate a peak signal, a comparator adapted to compare the threshold value with the peak signal and to generate a control signal identifying frequency of the peak, and a programmable notch-filter unit adapted to receive the control signal and operable to filter out a bandwidth of the sound signal in accordance with the control signal thereby generating the processed sound signal.

3. A classroom sound amplification system according to any of claims 1 or 2, wherein said microphone device comprises a microphone transmitter adapted to transmit the sound signal wirelessly to said sound processing device in accordance with a communication protocol.

4. A wireless classroom sound amplification system according to claim 1, wherein said sound processing device comprises a sound processing transmitter adapted to transmit the processed sound signal wirelessly to said speaker device in accordance with a communication protocol.

5. A wireless classroom sound amplification system according to claim 3, wherein said communication protocol comprises a proprietary protocol or a protocol such as Bluetooth, WLAN, WiMax, Wi-Fi, or other standardised communication protocols.

6. A wireless classroom sound amplification system according to claim 1, wherein said speaker device comprises an interactive white-board.

7. A wireless classroom sound amplification system according to claim 1, wherein said speaker device comprises a personal computer connecting to the sound processing device and adapted to receive images concurrent to the speaker device generating the processed voice.

8. A wireless classroom sound amplification system according to claim 7, wherein said speaker device is integral with the personal computer or is external devices plugged to the personal computer.

9. A wireless classroom sound amplification system according to claim 7, wherein said personal computer comprises a wireless receiver connecting to the sound processing transmitter and/or the microphone transmitter.

10. A wireless classroom sound amplification system according to claim 9, wherein said wireless receiver comprises a PCMCI card inserted into the personal computer.

11. A wireless classroom sound amplification system according to claim 7, wherein said personal computer connects to projecting means adapted to display a visual presentation.

12. A wireless classroom sound amplification system according to claim 7, wherein said personal computer further connects to a communications network

13. A wireless classroom sound amplification system according to claim 12, wherein said communications network interconnects the personal computer to a plurality of speaker devices and/or further personal computers.

14. A wireless classroom sound amplification system according to claim 7, wherein said personal computer comprises said sound processing device.

15. A wireless classroom sound amplification system according to claim 14, wherein said sound processing device is implemented in the personal computer as a computer program.

16. A wireless classroom sound amplification computer program to be executed on a personal computer and performing following operations:
(a) calculating a threshold value based on mean magnitude and standard deviation of a sound signal wirelessly received from a microphone device according to claim 1,
(b) transforming said sound signal into frequency domain,
(c) identifying a peak in said sound signal in frequency domain and generating a peak signal,
(d) comparing said threshold value with said peak signal and generating a control signal identifying frequency of said peak when said peak signal is above said threshold value,
(e) filtering out a bandwidth of said sound signal according to said control signal thereby generating a filtered sound signal,
(f) processing said filtered sound signal and generating a processed sound signal, and
(g) communicating said processed sound signal to a speaker device according to claim 1.
